(19) United States
(12) Patent Application Publication
(10) Pub. No.: US 2005/0007601 A1
(43) Pub. Date: Jan. 13, 2005

(54) Optical characterization of surfaces and plates

(76) Inventors: Ares J. Rosakis, Altadena, CA (US); David M. Owen, Redondo Beach, CA (US); Stephen Gledden, Fitzroy North (AU)

Correspondence Address: FISH & RICHARDSON, PC, 12390 EL CAMINO REAL, SAN DIEGO, CA, 92130-2081, US

(21) Appl. No.: 10/766,302

(22) Filed: Jan. 27, 2004

Related U.S. Application Data
(60) Provisional application No. 60/443,240, filed on Jan. 27, 2003.
(60) Provisional application No. 60/443,805, filed on Jan. 29, 2003.

(51) Int. Cl. G01B 9/02

(52) U.S. Cl. 356/521

(57) ABSTRACT

Techniques and systems for processing optical transmission of a plate in an optical shearing interferometer to measure the plate. Both optical reflection and optical transmission of the plate may be processed by optical shearing interferometers to obtain measurements of the plate, including surface information of at least one reflective surface, the wedge slopes, and variation in the refractive index of the plate, net optical distortions through plate assembly.

This application claims the benefits of U.S. Provisional Application No. 60/443,240 filed on Jan. 27, 2003, and U.S. Provisional Application No. 60/443,805 filed on Jan. 29, 2003. The entire disclosures of the above-referenced provisional patent applications are incorporated herein by reference as part of this application.

### BACKGROUND

This application relates to measurements of properties of surfaces and plates, and in particular, to the optical measurements and characterization of properties of surfaces and plates.

Surface and plate properties of panels and substrates, such as the surface flatness, surface curvatures, surface slopes, plate thickness and variations, and the spatial variations of the refractive indices of plates, and other surface and plates parameters are routinely measured and monitored in various applications. Substrates may be used as platforms to support various structures, such as microstructures integrated to the substrates. Integrated electronic circuits, integrated optical devices and opto-electronic circuits, micro-electro-mechanical systems, and flat panel display systems (e.g., LCD and plasma displays) are examples of such structures integrated on substrates. Measurements of surface properties of panels and substrates may be used to, e.g., ensure the surface properties to be within desired ranges or monitor and analyze surface stresses of the panels and substrates. Measurements of transverse uniformity profiles of plates, such as the wedge variations and variations in the refractive index, may be used in evaluating and manufacturing of reticles, masks and pellicles used in, e.g., photolithography.

### SUMMARY

This application describes exemplary implementations of optical measurements and characterization of surfaces by using full-field optical shearing interferometer systems, such as coherent gradient sensing (CGS) systems. Optical transmission through a wafer or plate may be processed by an optical shearing interferometer to obtain spatial slopes on wavefront distortions. Both optical reflection and optical transmission of the wafer or plate may be obtained and processed by the optical shearing interferometry to obtain information on at least one reflective surface, the plate thickness, and other parameters of the wafer or plate under measurement. As an example of the optical shearing interferometer systems, full-field CGS interferometry by reflection and transmission may be used as a tool for the study of optical wavefront distortion gradients associated with either or both of optical reflection and transmission of light obtained from a wafer or plate.

In one implementation, a system includes a sample holder to hold a sample, an optical input collimator to collimate an input probe beam, and to direct the input probe beam to the sample, a first optical shearing interferometer located to receive optical transmission of the input probe beam through the sample, a second optical shearing interferometer located to receive optical reflection of the input probe beam from the sample, and a processor to receive output signals from the first and the second optical shearing interferometers and operable to process the output signals to produce measurements of the sample.

In another implementation, an optical reflection off a sample plate is directed into a first optical shearing interferometer to obtain a first map of wavefront slopes of the optical reflection indicative of the reflective surface of the sample plate. In addition, an optical transmission through the sample plate is directed into a second optical shearing interferometer to obtain a second map of wavefront slopes of the optical transmission wavefront indicative of the variations in the optical path across the sample plate. The first and second maps are then processed to obtain information on the sample plate.

In yet another implementation, an optical probe beam with a uniform wavefront is directed to transmit through a sample plate. An optical shearing interferometer is used to receive optical transmission of the input probe beam through the sample plate to produce an optical shearing interference pattern. The optical shearing interference pattern is then processed to obtain a wavefront gradient map of the optical transmission.

These and other implementations are described in greater detail in the drawings, the detailed description, and the claims.

### BRIEF DESCRIPTION OF THE DRAWINGS

FIG. 1 illustrates optical measurement of an optically reflective surface by an optical probe beam, where the reflected probe beam is directed to gratings in a coherent gradient sensing (CGS) device or a non-CGS optical shearing interferometer.

FIG. 2 illustrates optical measurement of an optically transmissive surface by an optical probe beam.

FIG. 3 shows a coherent gradient sensing optical shearing interferometer having two spaced optical gratings to produce optical shearing.

FIG. 4 shows one example of an optical measurement system having two CGS devices in optical transmission and reflection modes, respectively.

FIG. 5 shows an example of an optical measurement system having three CGS devices.

### DETAILED DESCRIPTION

Examples of optical shearing interferometry techniques described in this application may use either or both of optical reflection at a surface and transmission through a plate of one or more collimated optical probe beams with a planar wavefront to measure optical distortions in the optical wavefront caused by optical reflection or transmission. The wavefront of the reflected or transmitted optical probe beam is optically sheared or shifted by the optical shearing interferometer to measure the local slope of the wavefront at a selected location and the slope map of the entire wavefront. A coherent gradient sensing (CGS) system, as one exemplary implementation of the optical shearing interferometry system, uses two optical gratings to produce the shifted wavefronts by diffraction and an imaging device to capture the desired diffraction orders. The interference pattern captured in the imaging device is then processed to obtain the slope information of the wavefront.

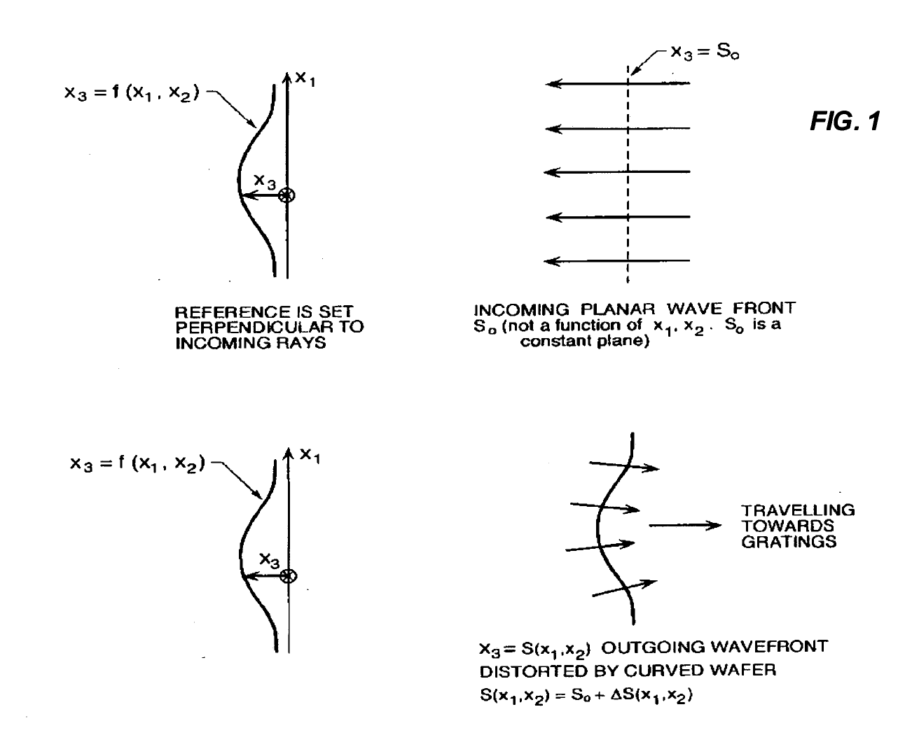

As an example, FIG. 1 illustrates a surface under measurement that is optically reflective at a selected probe wavelength. Assume the target surface under measurement features a non-uniform topology whose surface profile can be represented by the following equation
x₃=f(x₁,x₂), (1)
with respect to an arbitrarily chosen reference plane (x₁,x₂), where x₃ is perpendicular to both x₁ and x₂ and forms a Cartesian coordinate system with x₁ and x₂. When a collimated probe beam (initially planar wavefront) is reflected from this target surface, the reflected wavefront deviates from planarity due to the additional optical path traveled in the reflection process and can be characterized by the following equation:
x₃=S^{R}(x₁,x₂)=2f(x₁,x₂) (2)
This reflected wavefront, hence, “acquires” the spatial information on the target surface, including wavefront distortions by features present on the target surface. Optical shearing interferometry can be used to process the reflected wavefront to extract the surface profile information.

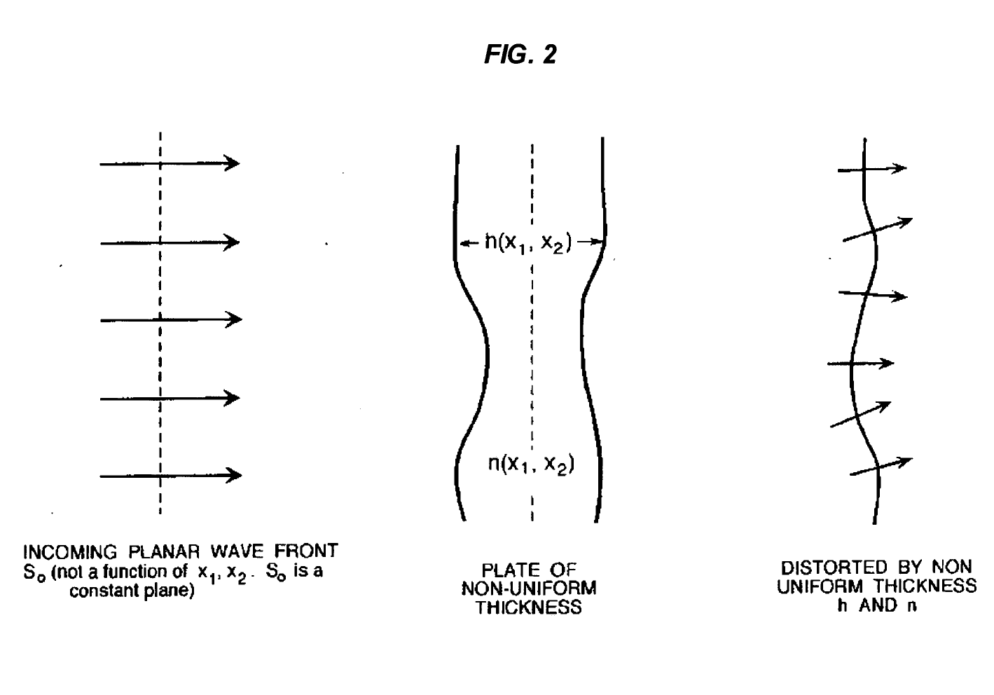

Next, consider a plate under measurement that is at least partially optically transmissive to a probe beam at a selected probe wavelength. The probe beam is collimated to have a planar wavefront prior to entry of the plate. FIG. 2 shows the plate is assumed to have a non-uniform thickness, h(x₁,x₂), and a spatially varying refractive index, n(x₁,x₂), both of which are measured with respect to a reference plane (x₁,x₂). The wavefront of the transmitted probe is distorted by the plate and can be characterized by the following equation:
S^{T}(x₁,x₂)=[n(x₁,x₂)−1]h(x₁,x₂) (3)
The above equation assumes that the plate is immersed in the air with a refractive index of 1. If the surround medium has a refractive index of n_{medium}, the “1” in the parentheses should be replaced by “n_{medium}.” The optical distortions on the reflected wavefront include distortions of the optical path associated with refractive index induced retardations and distortions caused by the non-uniform thickness h(x₁,x₂) of the plate. The non-uniform thickness introduces varying amounts of material in the path of the probe beam and thus distorts the initially planar wavefront by different amounts at different transverse locations on the plate. These two types of distortions are independent to each other. For example, when the thickness of the plate is uniform, the probe wavefront may still be distorted due to the spatial variation in the refractive index and vice versa.

After the distorted wavefront of a reflected probe beam or transmitted probe beam is obtained, the distorted wavefront may be subsequently optically processed in an optical shearing interferometer to obtain wavefront gradient information. Based on the wavefront gradient information, the surface topology and the surface slope map for the reflective surface under measurement may be extracted, and wedge and index variations (thickness and index derivatives or slopes) of the plate under measurement may also be obtained. Optical probing with both optical reflection and transmission may be used to measure surface properties and wedge variations of a plate. The optical reflection and transmission may be obtained simultaneously and be processed with two separate optical shearing interferometers.

One example of optical shearing interferometers is a coherent gradient sensing (CGS) system. Exemplary CGS implementations are described in U.S. Pat. No. 6,031,611, which is incorporated herein by reference in its entirety. The CGS interferometry may be used to measure the “surface slope” along one or more directions along the surface (e.g., ∂f/∂x₁, ∂f/∂x₂, in two orthogonal directions x1 and x2), maps of the wedge slopes of ∂h/∂x₁, ∂h/∂x₂, net wavefront gradient maps of ∂S^{T}/∂xₗ, ∂S^{T}/∂x₁, and full-field maps of opaque or transparent surfaces used in the microelectronics and optoelectronics industries. In some applications, it may be desirable to measure surface slopes and to subsequently integrate the surface slopes into topology of microelectronic or opto electronic wafer surfaces that have undergone various processing steps (e.g., Chemical Metal Polishing) where a resulting non-uniform surface finish (dishing/erosion) may have an adverse impact on device performance or effectiveness of subsequent processing steps.

Information on surface slopes, surface topology, wedge variations in index of refraction and thickness variations may be used to evaluate the quality and acceptability of photolithograph mask assemblies and their components such as substrates, mask blanks, and patterned masks, as well as mask assembly “pellicle plates” mounted in front of mask reticles for protection. Surface slopes and topology (height) variations may cause unacceptable misregistratoin errors during microfeature imaging. As the dimensions of microelectronic circuitry become increasingly smaller, the tolerances in acceptable mask surface slopes become more stringent. Hence, measurements of surface slopes are desirable. For reticle/pellicle assemblies, wavefront distortions associated with variations (gradients) in pellicle plate thickness, plate bending, and plate distortions due to mounting forces and gravity may also adversely affect the imaging quality on the wafer. Net assembly distortions are also a concern. Optical probing by transmission, based on CGS or another shearing interferometer, may be used to measure such effects. CGS and other optical shearing interferometry measurements by both reflection and by transmission may be used for assessing pellicle acceptability.

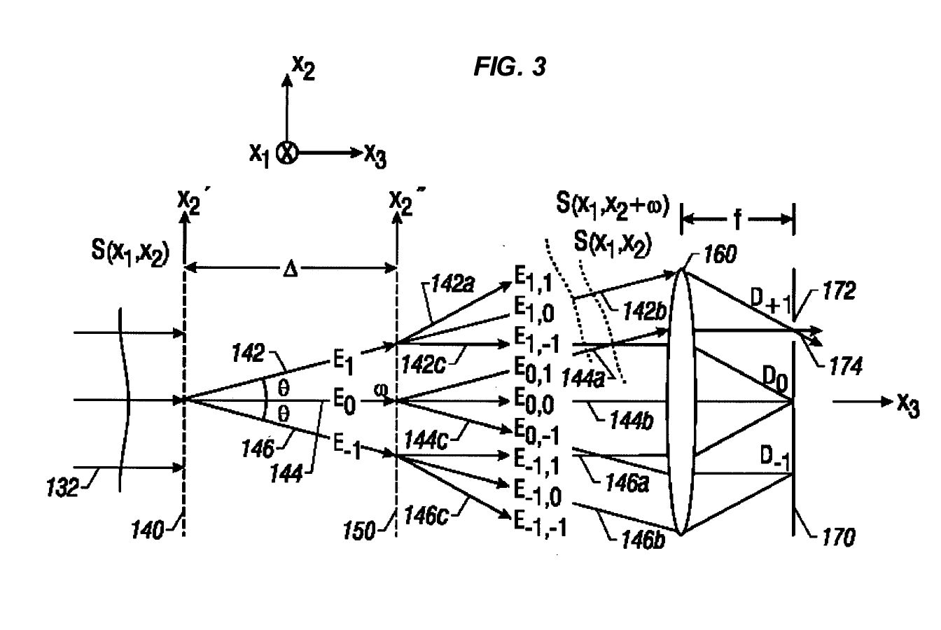

FIG. 3 shows one exemplary implementation of a CGS system with two spaced gratings 140 and 150 to process a distorted wavefront 132 that is generated by either optical reflection from a surface or optical transmission through a plate. The two gratings 140 and 150 in general may be any gratings, with different grating periods and oriented with respect to each other at any angle. In the illustrated example, the two gratings 140 and 150 are identical, i.e., they are oriented with respect to each other in the same direction and have the same grating periods to simplify the data processing. A Cartesian coordinate system (x1, x2, x3) is used in the following description where the x2 axis is parallel to the grating rulings of both the gratings 140 and 150.

The distorted wavefront 132 is processed through the gratings 140 and 150 situated at a distance (A) apart. A filtering lens 160 is used to produce a series of diffraction orders on a “filtering” plane where a camera 170 is focused on either the (+1) or the (−1) diffraction order. This system is described (for the case of reflection) in U.S. Pat. No. 6,031,611.

In operation, the grating 140 (G₁) diffracts the probe beam 132 into several diffraction waves denoted as E₀, E₁, E₋₁, E₂, E₋₂, etc. For illustrative purpose, only the first three diffraction orders, i.e., zero-order wave 144 (E₀), +1-order 142 (E₁), and −1-order wave 146 (E₋₁) are shown. Each of these wave fronts is further diffracted by the second grating 150 (G₂) to generate multiple wavefronts. For example, the +1-order 142 (E₁) is diffracted to produce wavefronts 142a (E_{1,1}), 142b (E_{1,0}), 142c (E_{1,1}), etc.; zero-order 144 (E₀) is diffracted to produce wavefronts 144a (E_{0,1}), 144b (E_{0,0}), 144c (E_{0,-1}), etc.; and −1-order 146 (E₋₁) is diffracted to produce wavefronts 146a (E_{-1,1}), 146b (E_{-1,0}) 146c (E_{-1,1}), etc.

Certain diffracted beams generated by the grating 150 from different diffraction orders generated by the grating 140 are parallel since the two gratings 140 and 150 are identical. This could also occur when the ratio of the grating periods of the two gratings 140, 150 is an integer. Under such conditions, a filtering lens 160 is used to overlap various sets of parallel diffracted beams emerged from the grating 150 with one another at or near the filtering plane 170 to form multiple diffraction spots. These diffraction spots have interference fringes due to the interference of the overlapped beams. The interference fringes have information indicative of the gradient of the phase distortion in the wavefront of the probe beam 132.

For example, the zero-order diffraction beam 142b (E_{1,0}) originated from the beam 142 is parallel to the +1-order diffraction beam 144a (E_{0,1}) originated from the beam 144. These two beams 142b and 144a are focused to a point 174 (D₊₁) on the filter place 170 by the lens 160. Similarly, the diffracted beams 142c and 144b overlap and interfere with each other to form a spot D₀, and beams 144c and 146b overlap and interfere with each other to form a spot D₋₁, respectively.

The interference pattern of any of these spots has the information of the gradient of the phase distortion in the wavefront of the probe beam 132 and can be used to determine the slope and curvature of the specimen surface 130. The example in FIG. 3 shows the spot 174 (D₊₁) is selected by the aperture 172 in the filter plane.

As the wavefront goes through the CGS system an optical differentiation of the distorted wavefront is performed. The resulting interference pattern is governed by the following equations:

$$\frac{\partial S}{\partial {x}_{α}} = \frac{kp}{Δ} , \qquad ( 4 )$$

where S=S^{R} for reflection probing and S=S^{T} for transmission probing, k is an integer and where a is either 1 or 2 depending on the direction of the gratings relative to the transverse x₁, x₂ axes. In CGS optical probing based on optical reflection, Equations (2) and (4) result in the following relation governing slope component measurement through CGS interferometry:

$$\frac{\partial f}{\partial {x}_{α}} = \frac{kp}{2 Δ} . \qquad ( 5 )$$

Based on Equations (4) and (5), the spacing A between the two gratings may be adjusted, either continuously or discontinuously, to vary the shearing distance in order to adjust the measurement resolution.

For optical probing by transmission, the wavefront slope may be derived from Equations (3) and (5):

$$\frac{\partial {S}^{T}}{\partial {x}_{α}} = [ n ( {x}_{1} , {x}_{2} ) - 1 ] \frac{\partial h}{\partial {x}_{α}} + \frac{\partial n}{\partial {x}_{α}} h ( {x}_{1} , {x}_{2} ) = \frac{kp}{Δ} . \qquad ( 6 )$$

Equation (6) is the relation governing net wavefront distortion gradient measurement (in transmission) through CGS interferometry.

Hence, the CGS interferometry may be used to construct full-field maps of both surface slope components ∂f/∂x₁ and ∂f/∂x₂ of a reflective surface through the use of Equations (2) and (4). Numerical integration of these independent slope component maps may be used to construct the surface topology or height relative to a reference (to be achieved up to an arbitrary rigid body translation and rotation).

The CGS interferometry in transmission may be used for construction of full-field maps of transmitted optical surface distortion gradients ∂S^{T}/∂x₁ and ∂S^{T}/∂x₂ through a plate that is transmissive to light at the probe light wavelength. For the case of a single plate element of uniform refractive index, n(x₁,x₂)=n=const, Equation (6) provides:

$$\frac{\partial {S}^{T}}{\partial {x}_{α}} = \frac{kp}{Δ} = ( n - 1 ) \frac{\partial h}{\partial {x}_{α}} . \qquad ( 7 )$$

As a result, the thickness or wedge variation may be expressed as

$$\frac{\partial h}{\partial {x}_{α}} = \frac{kp}{( n - 1 ) Δ} . \qquad ( 8 )$$

Therefore, CGS may be used as a method for measuring the “wedge slope” components ∂h/∂x₁ xand ∂h/∂x₂ or the thickness gradient maps of transmissive plates. The shearing distance Δ may be either continuously or discontinuously adjusted to change the measurement resolution in the transmission mode. Integration of such slope components will result in the construction of optical surface distortions or to net wedge maps, respectively.

Multiple reflections of light may be present in a transmissive plate as a result of partial and multiple reflections and refractions of the light from the two opposing surfaces. Such multiple reflections may complicate optical detection of either or both of the optical reflection and transmission by using optical shearing inteferometry. The CGS may be advantageously used in this situation because operation of a CGS inteferometer is independent of a probe wavelength as indicated by the governing equations of CGS in Eqs. (4), (5), and (7). For example, a probe wavelength may be selected so that a plate under measurement is optically opaque or non-transmissive at the selected probe wavelength. This eliminates multiple reflections and refractions thus allowing for an accurate surface slope and topology measurements by CGS probing based on optical reflection. In addition, two different probe beams with different probe wavelengths may be used, one being transmissive and other being reflective, in measuring a plate by using two optical shearing inteferometers to respectively process the optical reflection and the optical transmission.

Some mounted reticle/pellicle assemblies or other optical element assemblies may be fully or partially transmissive to light. To measure these devices, the transmission CGS may be used to obtain the wavefront slope and Equation (6) may be used for evaluating the NET optical distortion gradients of the entire assembly as a test of suitability.

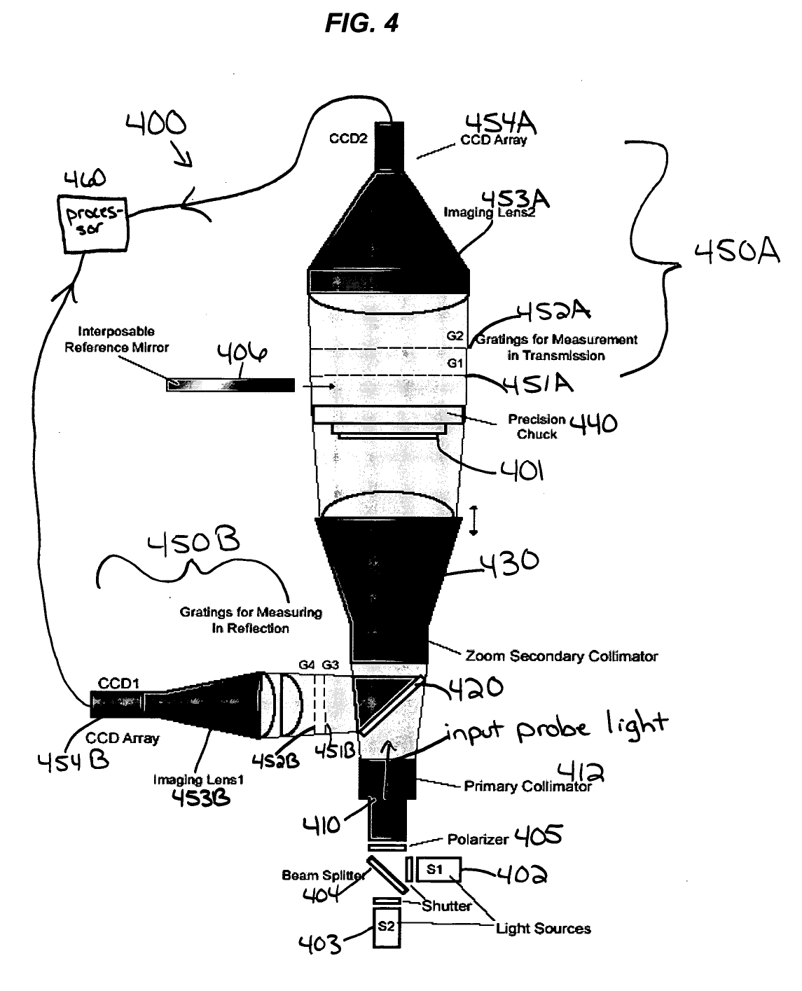

FIG. 4 shows one exemplary CGS system 400 that includes a first CGS device 450A to measure optical transmission of a sample 401 and a second CGS device 450B to measure optical reflection of the sample 401. Similar to the CGS system shown in FIG. 3, each of the CGS devices 450A and 450B includes two gratings, i.e., 451A(G1) and 452A(G2) or 451B(G3) and 452B(G4), a spatial filtering imaging lens (453A or 453B), and an imaging sensor such as a CCD array (454A or 454B). A sample holder 440 is provided to support and hold the sample 401 under measurement. A precision chuck may be used as the sample holder 440. A processor 460 is provided to receive output signals from the CGS devices 450A and 450B and operates to process the signals to produce measurement results. The processor 460 may be programmed with the processing the above-described algorithms for both the reflection and the transmission CGS measurements.

An input optical collimator 410 is used to receive and collimate input probe light. The collimated input probe light is directed to the sample 401. A partially transmissive beam splitter 420 is located in the optical path of the input probe light between the input optical collimator 410 and the sample 401 to reflect a portion of the reflected probe light from the sample 401 to the second CGS device 450B. A second optical collimator 430 may be located between the beam splitter 420 and the sample 401 to collimate light.

The system 400 may include one or more light sources may be used to generate probe light at a desired probe wavelength. For a given sample plate, the probe wavelength may be selected or tuned to be optically reflective at the sample plate to use the CGS device 450B to measure the reflective surface of the sample plate. Alternatively, the probe wavelength may be selected or tuned to be optically transmissive at the sample plate to use the CGS device 450A to measure the variations of the optical thickness of the plate. In addition, two different probe wavelengths may be used at the same time with one being reflected by the sample plate and the other being transmissive to the sample plate to measure both the front surface and the variations in the overall optical path of the sample plate. As illustrated, the system 400 in this example has two light sources 402 and 403 operating at different probe wavelengths. A wavelength-selective beam splitter 404, e.g., a dichotic beam splitter, may be used to combine and direct probe beams at different probe wavelengths to the input collimator 410.

The system 400 may be operated to provide near instantaneous, full-field data collection across the entire specimen surface. The CGS devices in both optical reflection and transmission modes allow for full-field measurements of surface flatness, surface wedge, surface slope, and surface topology of reticles and pellicles using CGS interferometry. This system may also measure the impact of reticles, pellicles, and reticle/pellicle assemblies on optical wavefronts passing through them by evaluating wavefront flatness, wavefront slope, and wavefront topology. In addition, measurements may also be obtained for the tilt, flatness, wedge, and Total System Optical Distortion (TSOD) of the reticle, pellicle, and reticle/pellicle assembly.

The system 400 may be configured to include various beneficial features. For example, the sample holder 440 and the optical systems may be designed to have a large circular field of view to accommodate large square substrates and reticles, e.g., a 9-inch circular view for up to 6″ square reticles. The combination of CGS interferometry in both transmission and reflection and use of at least two different probe wavelengths provide powerful and versatile probing capabilities for various measurements. Depending on the measurement requirements, the system may also incorporate multiple angles of incidence and multiple shearing distances.

In implementations of the system 400 in FIG. 4, the system may use two separate coherent light sources controlled by a mechanical shutter in front of each light source. The probe wavefront may be directed to pass through an auto-zoom optical system where the beam is polarized, collimated, and expanded upon incidence on the sample. The sample holder 440 may be an electrostatic chuck with multi-degree adjustments capable of precisely positioning the specimen and, possibly, varying the angle of incidence.

In operation, the system 400 may utilize various mechanisms to optically distinguish between front and backside surfaces, including but not limited to varying or tuning the probe wavelength, varying or tuning the shearing distance (i.e., spacing of the gratings), and varying or tuning the angle of incidence of the probe wavefront. The system may be used to measure patterned and discontinuous wavefronts. When the probe wavelength is used to distinguish the front and backside surfaces, a tunable probe light source or multiple probe light sources at different probe wavelengths may be used. A special probe wavelength may be used to measure the front surface only by optical reflection when the probe light does not transmits through the front surface, e.g., when the material for the wafer or substrate is opaque at the selected wavelength. The probe wavelength may be changed to a second probe wavelength that transmits through the wafer or substrate to produce an optical transmission. In addition, the polarization of the probe beam may also be used to distinguish the front and backside surfaces of a wafer or substrate. At an interface from between two different dielectric materials, the p-polarized light is not reflected and is entirely refracted when the incident angle is at or greater than the Brewster angle of the interferface. Hence, the incident polarization may be controlled to facilitate separation of measurements of the front and the backside surfaces. As an example, a probe beam in the p-polarization and a second probe beam in the s-polarization may be simultaneously directed to the sample as two separate probe beams.

In the system 400 in FIG. 4, a single reflection from the sample plate 401 may be obtained and processed by the CGS device 450B under proper conditions. This single reflection measurement can be used to measure the reflecting surface in the front of the plate 401. Alternatively, the opposite surface of the sample 401 may also be measured by optical reflection and the CGS device 450B when the sample 401 may be flipped on the chuck 440.

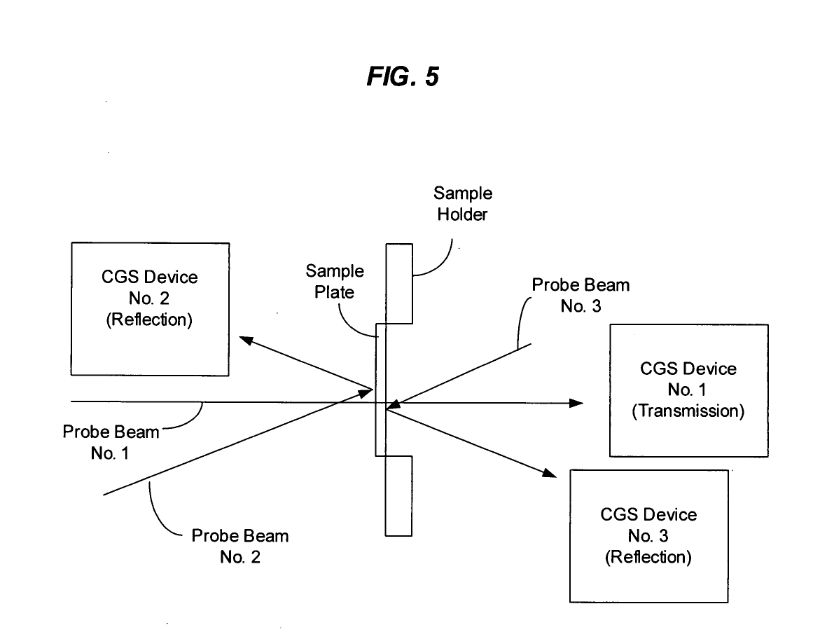

FIG. 5 illustrates an exemplary system having 3 CGS devices to respectively measure two opposing surfaces of a sample plate by two CGS devices in optical reflection modes and a third CGS device in an optical transmission mode. The probe beam for the optical transmission mode may have a wavelength different from the probe beams used in the optical reflection modes. Each probe beam for optical reflection may have a wavelength at which the light does not transmits into the plate so multiple reflections and refractions may be eliminated. Hence, this system may be used to simultaneously obtain two surface measurements by two separate reflections and the transmission measurement for variations in the plate thickness slopes or the slopes of the refractive index.

The CGS measures wavefront slope directly and thus offers significant benefits over conventional topological or net wavefront shape interferometric approaches. For example, the CGS can eliminate the need for numerical differentiation of the wavefront measurement, thereby improving measurement quality and integrity by directly monitoring unwanted variations (gradients) of optical distortion. As another example, CGS can measure discontinuous wavefronts, e.g., those that have already passed through a reticle, or a pellicle, or a combination of a reticle and a pellicle. In addition, the spacing between two spaced gratings in a CGS interferometer may be adjusted, either continuously or discontinuously, to provide a variable sensitivity in CGS measurements.

The above CGS interferometry devices are specific examples of full-field optical shearing interferometers. Other shearing interferometers may also be implemented for the CGS devices 450A and 450B in the system 400 in FIG. 4. In general, a shearing interferometer optically processes a distorted wavefront to cause wavefront interference. This interference is caused by optically shearing or shifting the wavefront and is used to measure the local slope of a wavefront and surface topology deviations. Such a shearing interferometer directs the distorted wavefront through a device or component of the system designed to optically shear or shift the wavefront enabling the measurement of wavefront slope. In addition to CGS, other examples of shearing interferometers and shearing devices or components include a radial shear interferometers, wedge plate in a Bi-Lateral Shearing Interferometer (U.S. Pat. No. 5,710,631), and others.

The use of optical shearing interferometry present certain advantages in optically measuring surfaces including surfaces patterned with various microstructures such as patterned wafers and patterned mask substrates used (in-delete) to support, e.g., integrated circuits, integrated optical devices, integrated opto-electronic devices, and MEMs devices. In addition, an optical shearing interferometer may be used in the in-situ monitoring of the surface properties such as curvatures and related stresses during fabrication of devices at the wafer level and the measurements may be used to control in real time, the fabrication conditions or parameters. As an example, measurement and operation of an optical shearing interferometer generally is not significantly affected by rigid body translations and rotations due to the self-referencing nature of the optical shearing interferometry. Hence, a wafer or device under measurement may be measured by directing a probe beam substantially normal to the surface or at low incident angles without affecting the measurements. By shifting or shearing the wavefront, the optical shearing interferometer measures the deformation of one point of the wavefront to another separated by the shearing distance, i.e., the distance between the two interfering replicas of the same wavefront. In this sense, the optical shearing interferometer is self referencing and thus increases its insensitivity or immunity to vibrations of the wafer or device under measurement. This resistance to vibrations may be particularly advantageous when the measurement is performed in a production environment or in situ, during a particular process (e.g. deposition within a chamber), where vibration isolation is a substantial challenge.

A surface with device patterning poses several challenges for conventional (non-shearing) interferometers. A conventional interferometer generates wavefront interference of topology or topography based on interference between a wavefront reflected from a sample and a wavefront reflected from a known reference. Conventional interferometers used to measure surfaces with device patterning are frequently ineffective as the relatively non-uniform or diffuse wavefront reflected off the patterned surface does not interfere coherently with the wavefront reflected off the reference mirror, preventing the unwrapping and interpretation of the interferometric image.

In applying shearing interferometry for measuring patterned wafers, the patterned wafers, e.g., semiconductor and optoelectronic wafers with diameters of 200 mm, 300 mm, etc., may be placed in a shearing interferometer in a configuration that allows a collimated probe beam to be reflected off the wafer surface. Using a shearing interferometer on a patterned wafer results in coherent interference because the two interfering wavefronts are substantially similar in shape after being sheared by a small distance. Although each wavefront reflected off a patterned surface may be inherently noisy and diffuse, there is sufficient coherence between the wavefronts for meaningful fringe patterns to form and be interpreted when recombined in this fashion.

The method for using shearing interferometers to measure patterned wafers may be further improved with the use of phase shifting. Phase shifting may be implemented to progressively adjust the phase separation between interfering wavefronts which cycles or manipulates fringe position on the specimen's surface. In one implementation, a shearing interferometer may be configured to obtain multiple phased images of a patterned wafer's surface, for example at 0, 90, 180, 270 and 360 degrees in phase. The phase shifting method allows for wavefront slope to be measured by calculating the “relative phase” modulation at each pixel on a detector array. The method also allows for consistent interpretation of wavefront and specimen slope on a surface that exhibits changing reflectivity, like those found on patterned wafers. On a patterned wafer surface each pixel location on the specimen will reflect light with varying degrees of intensity, complicating the interpretation of any single sheared interferogram. Employing phase shifting simultaneously increases the accuracy of the slope resolution and allows accurate interpretation of interferograms on Patterned Surfaces with varying reflectivity by measuring the relative phase of each pixel rather than fringe separation or variation in the fringe intensity.

Having collected multiple phase shifted interferograms of the patterned wafer surface, an unwrapping algorithm may be subsequently used for the accurate interpretation of surface slopes. Suitable unwrapping algorithms include, but are not limited to, Minimum Discontinuity (MDF) and Preconditioned Conjugate Gradient (PCG).

Once the interferograms have been unwrapped the interpretation of raw slope data and the derivation of curvature is further enhanced by statistically fitting a surface polynomial to the raw slope data. Statistical surface fits, including Zernicke polynomials, may be applied to raw slope data derived from Patterned Wafers for the purpose of deriving topology and curvature data.

In the CGS system shown in FIG. 3, the phase shifting may be achieved by adjusting the relative position of the two gratings 140 and 150 in the plane defined by x1 and x2 that is perpendicular to the x3 direction while the separation between the gratings along the x3 direction is fixed. A positioning mechanism, such as precise translation stage or a positioning transducer may be used to implement this adjustment of the relative position between the gratings for phase shifting.

Another feature of the shearing interferometry is that the wavefront is optically differentiated once and the optical differentiation is recorded in the shearing interference pattern. Hence, only a single derivative operation on the data from the shearing interference pattern is sufficient to calculate curvatures from slopes of the wavefront. Also, because the shearing interferometry method provides full-field interferometric data it can utilize many more data points compared to other methods such as the method of using a conventional capacitive probe to measure a few points of surface topology. This higher data density provides more accurate measurements and better resistance to noise than other methods which feature much less density of measured data. In addition, although various laser beam scanning tools may be used to measure wafer bow or surface curvature, these methods typically measure radial curvature only. Shearing interferometry may easily measure slopes in two orthogonal directions allowing elucidation of the full curvature tensor and stress state of the wafer or fabricated structures on the wafer.

Only a few implementations are described. Other variations and enhancements may be possible.

1. A system, comprising:
a sample holder to hold a sample;
an optical input collimator to collimate an input probe beam, and to direct the input probe beam to the sample;
a first optical shearing interferometer located to receive optical transmission of the input probe beam through the sample;
a second optical shearing interferometer located to receive optical reflection of the input probe beam from the sample; and
a processor to receive output signals from the first and the second optical shearing interferometers and operable to process the output signals to produce measurements of the sample.

2. The system as in claim 1, wherein the first and the second optical shearing interferometers are coherent gradient sensing (CGS) devices.

3. The system as in claim 2, wherein each CGS device comprises two spaced gratings whose spacing is adjustable to change a measurement resolution.

4. The system as in claim 3, further comprising a mechanism to adjustably change a relative transverse position between the two gratings without changing the spacing between the two gratings to cause a phase shift in each CGS device.

5. The system as in claim 1, further comprising a first light source to produce a first probe beam at a first probe wavelength that transmits through the sample to the first optical shearing interferometer, and a second light source to produce a second probe beam, at a second probe wavelength, that reflects at the sample to the second optical shearing interferometer.

6. The system as in claim 1, wherein the processor operates to produce full-field measurements of surface flatness, surface wedge, surface slope, and surface topology of the sample.

7. The system as in claim 1, wherein the first optical shearing interferometer is different from a CGS device.

8. A method, comprising:
directing an optical reflection off a sample plate into a first optical shearing interferometer to obtain a first map of wavefront slopes of the optical reflection indicative of the reflective surface of the sample plate;
directing an optical transmission through the sample plate into a second optical shearing interferometer to obtain a second map of wavefront slopes of the optical transmission wavefront indicative of the variations in the optical path across the sample plate; and
processing the first and second maps to obtain information on the sample plate.

9. The method as in claim 8, further comprising adjusting incident angle of input probe light to the sample plate.

10. The method as in claim 8, wherein each optical shearing interferometer is a CGS device having two spaced gratings, the method further comprising varying the spacing of the gratings to change a measurement resolution.

11. The method as in claim 8, further comprising adjusting a wavelength of input probe light to the sample plate.

12. The method as in claim 8, wherein each optical shearing interferometer is a CGS device having two spaced gratings, the method further comprising adjusting a relative transverse position between the two gratings without changing the spacing between the two gratings to cause a phase shift in each CGS device.

13. The method as in claim 8, further comprising:
directing optical reflection off a second reflective surface of the sample plate into a third optical shearing interferometer to obtain a third map of wavefront slopes of the optical reflection indicative of the second reflective surface of the sample plate,
wherein the processing further includes processing the third map.

14. The method as in claim 8, wherein the information to be obtained on the sample plate includes at least one of a surface flatness, surface wedge, surface slope, and surface topology of the sample plate.

15. The method as in claim 8, further comprising controlling optical polarization of a probe beam incident to the sample plate.

16. A method, comprising:
directing an optical probe beam with a uniform wavefront to transmit through a sample plate;
using an optical shearing interferometer to receive optical transmission of the input probe beam through the sample plate to produce an optical shearing interference pattern; and
processing the optical shearing interference pattern to obtain a wavefront gradient map of the optical transmission.

17. The method as in claim 16, further comprising processing the wavefront gradient to obtain a wedge slope map of the thickness of the sample plate.

18. The method as in claim 16, further comprising processing the wavefront gradient to obtain a slope map of a refractive index of the sample plate.

19. The method as in claim 16, wherein the optical shearing interferometer comprises two spaced gratings to produce the optical shearing interference pattern, the method comprising adjusting a spacing between the two gratings to change a measurement resolution.

20. The method as in claim 16, wherein the optical shearing interferometer comprises two spaced gratings to produce the optical shearing interference pattern, the method comprising adjusting a relative transverse position between the two gratings to cause a phase shift.
